(19) United States
(12) Patent Application Publication
(10) Pub. No.: US 2013/0290994 A1
(43) Pub. Date: Oct. 31, 2013

(54) SELECTION OF TARGETED CONTENT BASED ON USER REACTIONS TO CONTENT

(71) Applicants: Leonardo Alves Machado, Porto Alegre Rio Grande Do Sul (BR); Soma Sundaram Santhiveeran, Fremont, CA (US); Diogo Strube de Lima, Porto Alegre Rio Grande Do Sul (BR); Walter Flores Pereira, Porto Alegre (BR)

(72) Inventors: Leonardo Alves Machado, Porto Alegre Rio Grande Do Sul (BR); Soma Sundaram Santhiveeran, Fremont, CA (US); Diogo Strube de Lima, Porto Alegre Rio Grande Do Sul (BR); Walter Flores Pereira, Porto Alegre (BR)

(21) Appl. No.: 13/457,586

(22) Filed: Apr. 27, 2012

(51) Int. Cl. H04N 21/258

(52) U.S. Cl. 725/12

(57) ABSTRACT

Techniques for selecting a targeted content item for playback are described in various implementations. A method that implements the techniques may include receiving, from an image capture device, an image that includes a user who is viewing a first content item being displayed on a presentation device. The method may also include processing the image to identify a facial expression of the user, and determining an indication of user reaction to the first content item based on the identified facial expression of the user. The method may further include comparing the indication of user reaction to an indication of intended reaction associated with the first content item to determine an efficacy value of the first content item. The method may also include selecting a targeted content item for playback on the presentation device based on the efficacy value.

### BACKGROUND

Advertising is a tool for marketing goods and services, attracting customer patronage, or otherwise communicating a message to an audience. Advertisements are typically presented through various types of media including, for example, television, radio, print, billboard (or other outdoor signage), Internet, digital signage, mobile device screens, and the like.

Digital signs, such as LED, LCD, plasma, and projected images, can be found in public and private environments, such as retail stores, corporate campuses, and other locations. The components of a typical digital signage installation may include one or more display screens, one or more media players, and a content management server. Sometimes two or more of these components may be combined into a single device, but typical installations generally include a separate display screen, media player, and content management server connected to the media player over a private network.

Regardless of how advertising media is presented, whether via a digital sign or other mechanisms, advertisements are typically presented with the intention of commanding the attention of the audience and to induce prospective customers to purchase the advertised goods or services, or otherwise be receptive to the message being conveyed.

### BRIEF DESCRIPTION OF THE DRAWINGS

FIG. 1 is a conceptual diagram of an example digital display system.

FIG. 2 is a block diagram of an example system for providing targeted content based on user reactions.

FIG. 3 is a flow diagram of an example process for selecting targeted content based on user reactions.

### DETAILED DESCRIPTION

Traditional mass advertising, including digital signage advertising, is a non-selective medium. As a consequence, it may be difficult to reach a precisely defined market segment. The volatility of the market segment, especially with placement of digital signs in public settings, is heightened due to the changing variations in the composition of audiences. In many circumstances, the content may be selected and delivered for display on a digital sign based on a general understanding of the consumer tendencies considering time of day, geographic coverage, or the like.

According to the techniques described here, targeted content may be selected for presentation, e.g., on a display of a digital signage installation, based in part on a user's reaction to the current content being displayed. In some implementations, an image capture device may capture an image that includes a user who is viewing the current content being displayed. For example, a video camera may be positioned near a display to capture an audience of one or more individuals located in the vicinity of the display (e.g., individuals directly in front of the display or within viewing distance of the display, etc.), and may provide a still image or a set of one or more frames of video to a content computer for analysis.

The content computer may process the image to identify a facial expression of the user viewing the current content. For example, the content computer may extract from the image one or more facial features of the user and the relative positioning of such facial features, and may identify that the specific combination of features and positioning correspond to a particular facial expression. The content computer may then determine an indication of the user's reaction to the current content based at least in part on the user's facial expression. For example, the content computer may determine that the user is happy or entertained by the content, e.g., if the user is smiling or laughing. Or, the content computer may determine that the user is unhappy or frustrated with the content, e.g., if the user is frowning or shaking her head.

The content computer may compare the indication of the user reaction to an indication of an intended reaction associated with the current content to determine an efficacy value of the current content. The efficacy value may represent a level of correlation between the user reaction and the intended reaction. For example, if the user is entertained by content that is intended to be funny, or if the user is frustrated with content that is intended to be consternating, then the efficacy value may indicate a match (or a positive correlation) between the user's reaction and the intended reaction. On the other hand, if the user is entertained with content that is intended to be unpleasant, or if the user is frustrated by content that is supposed to be funny, then the efficacy value may indicate a disconnect between the actual and intended reactions.

The content computer may then select a targeted content item for playback on the display based on the efficacy value. For example, if the current content is intended to be entertaining, and the user is observed to be laughing (e.g., the efficacy value indicates a positive correlation between actual and intended reactions), then another entertaining content item may be targeted for display to the user, and may be queued for playback after the current content has finished playing. However, if the user is instead observed to be frowning at content that is intended to be entertaining, then the content computer may select a different type of content for display to the user. In some cases, the content computer may also interrupt playback of the current content and replace it with the different type of content, e.g., in response to a low efficacy value.

In some implementations, the use of user reaction feedback in such a manner may provide an improved understanding of the efficacy of content that is being displayed without storing any personal data about the viewers of the content. The improved understanding of the efficacy of the content may allow more relevant content to be displayed to the audience, which in turn may lead to increased user engagement with the digital sign, increased return on investment for operators of the digital sign, and/or increased usability of the digital sign. These and other possible benefits and advantages will be apparent from the figures and from the description that follows.

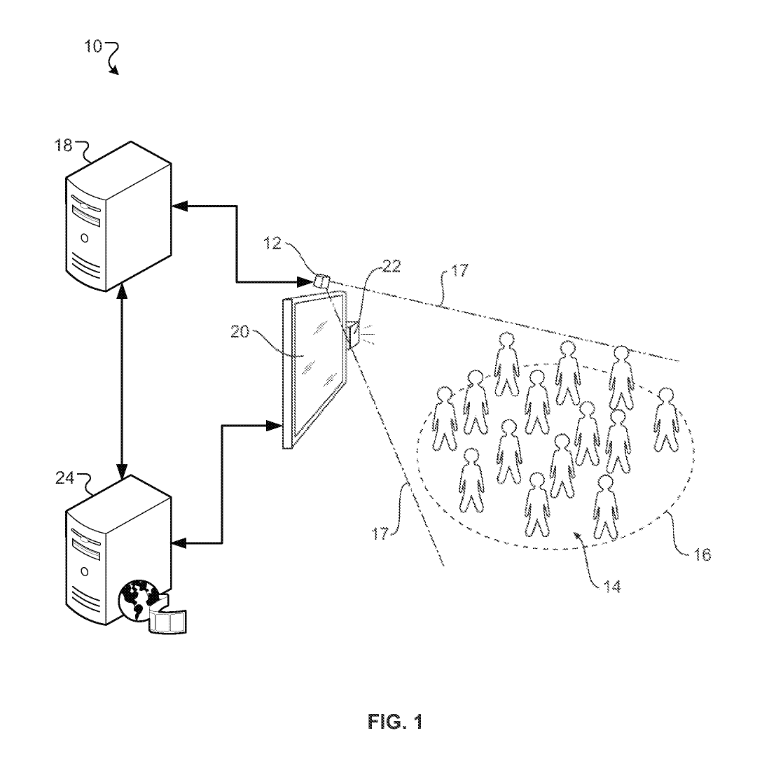

FIG. 1 is a conceptual diagram of an example digital display system 10. The system includes at least one imaging device 12 (e.g., a camera) pointed at an audience 14 (located in an audience area indicated by outline 16 that represents at least a portion of the field of view of the imaging device), and a content computer 18, which may be communicatively coupled to the imaging device 12 and configured to select targeted content for users of the digital display system 10.

The content computer 18 may include image analysis functionality, and may be configured to analyze visual images taken by the imaging device 12. The term “computer” as used here should be considered broadly as referring to a personal computer, a portable computer, an embedded computer, a content server, a network PC, a personal digital assistant (PDA), a smartphone, a cellular telephone, or any other appropriate computing device that is capable of performing functions for receiving input from and/or providing control for driving output to the various devices associated with an interactive display system.

Imaging device 12 may be configured to capture video images (i.e. a series of sequential video frames) at any desired frame rate, or to take still images, or both. The imaging device 12 may be a still camera, a video camera, or other appropriate type of device that is capable of capturing images. Imaging device 12 may be positioned near a changeable display device 20, such as a CRT, LCD screen, plasma display, LED display, display wall, projection display (front or rear projection), or any other appropriate type of display device. For example, in a digital signage application, the display device 20 can be a small or large size public display, and can be a single display, or multiple individual displays that are combined together to provide a single composite image in a tiled display. The display may also include one or more projected images that can be tiled together or combined or superimposed in various ways to create a display. An audio output device, such as an audio speaker 22, may also be positioned near the display, or integrated with the display, to broadcast audio content along with the visual content provided on the display.

The digital display system 10 also includes a display computer 24 that is communicatively coupled to the display device 20 and/or the audio speaker 22 to provide the desired video and/or audio for presentation. The content computer 18 is communicatively coupled to the display computer 24, allowing feedback and analysis from the content computer 18 to be used by the display computer 24. The content computer 18 and/or the display computer 24 may also provide feedback to a video camera controller (not shown) that may issue appropriate commands to the imaging device 12 for changing the focus, zoom, field of view, and/or physical orientation of the device (e.g. pan, tilt, roll), if the mechanisms to do so are implemented in the imaging device 12.

In some implementations, a single computer may be used to control both the imaging device 12 and the display device 20. For example, the single computer may be configured to handle all functions of video image analysis, content selection, and control of the imaging device, as well as controlling output to the display. In other implementations, the functionality described here may be implemented by different or additional components, or the components may be connected in a different manner than is shown. Additionally, the digital display system 10 can be a network, a part of a network, or can be interconnected to a network. The network can be a local area network (LAN), or any other appropriate type of computer network, including a web of interconnected computers and computer networks, such as the Internet.

The content computer 18 can be any appropriate type of computing device, such as a device that includes a processing unit, a system memory, and a system bus that couples the processing unit to the various components of the computing device. The processing unit may include one or more processors, each of which may be in the form of any one of various commercially available processors. Generally, the processors may receive instructions and data from a read-only memory and/or a random access memory. The computing device may also include a hard drive, a floppy drive, and/or a CD-ROM drive that are connected to the system bus by respective interfaces. The hard drive, floppy drive, and/or CD-ROM drive may access respective non-transitory computer-readable media that provide non-volatile or persistent storage for data, data structures, and computer-executable instructions to perform portions of the functionality described here. Other computer-readable storage devices (e.g., magnetic tape drives, flash memory devices, digital versatile disks, or the like) may also be used with the content computer 18.

The imaging device 12 may be oriented toward an audience 14 of individual people, who are gathered in an audience area, designated by outline 16. While the audience area is shown as a definite outline having a particular shape, this is intended to represent that there is some appropriate area in which an audience can be viewed. The audience area can be of a variety of shapes, and can comprise the entirety of the field of view 17 of the imaging device, or some portion of the field of view. For example, some individuals can be near the audience area and perhaps even within the field of view of the imaging device, and yet not be within the audience area that will be analyzed by the content computer 18.

In operation, the imaging device 12 captures an image of the audience, which may involve capturing a single snapshot or a series of frames (e.g., in a video). Imaging device 12 may capture a view of the entire field of view, or a portion of the field of view (e.g. a physical region, black/white vs. color, etc). Additionally, it should be understood that additional imaging devices (not shown) can also be used, e.g., simultaneously, to capture images for processing. The image (or images) of the audience may then be transmitted to the content computer 18 for processing.

Content computer 18 may receive the image or images (e.g., the audience view from imaging device 12 and/or one or more other views), and may process the image(s) to identify one or more distinct audience members included in the image. Content computer 18 may use any appropriate face or object detection methodology to identify distinct individuals captured in the image.

Content computer 18 may also process the image(s) to identify a facial expression associated with one or more of the audience members. For example, content computer 18 may extract from the image one or more facial features and the relative positioning of such facial features for a particular audience member, and may determine that the specific combination of features and positioning correspond to a particular facial expression for that audience member. In some cases, such a determination may be made for all of the users in the audience, or for one or more selected audience members (e.g., based on the users' relative proximity to the device, or on other criteria for selecting a particular audience member or subset of audience members). As used here, the term “facial expression” should be considered broadly to include various articulations associated with a user's face and/or head, and may therefore include expressions such as smiling, frowning, grimacing, smirking, laughing, nodding, head shaking, averting of the head and/or eyes, pupil dilation, and the like.

Content computer 18 may then determine an indication of the user's reaction to the current content based at least in part on the user's facial expression. For example, the content computer may determine that the user is happy or entertained by the content, e.g., if the user is smiling or laughing. Or, the content computer may determine that the user is unhappy or frustrated with the content, e.g., if the user is frowning or shaking her head.

In some implementations, content computer 18 may map one or more facial expressions to an indication of the user's reaction to the content based on a rule set that describes how various facial expressions should be interpreted. The rule set may be configurable, and may include weightings that allow an administrator to fine-tune how various user reactions are defined, e.g., according to cultural or social norms in the area where the digital signage installation is to be located, or according to known models that provide an effective determination of what various facial expressions may mean in a given context. For example, a wry smile may be interpreted one way in some cultures and in an entirely different way in other cultures.

In some implementations, the indication of the user's reaction to the current content may include a numerical score on a likability scale, e.g., where a score of ten (based on an expression of amazement, dilated pupils, and a smile) indicates that the user very much likes the content, and a score of one (based on an expression of disgust) indicates that the user very much dislikes the content. In some implementations, the indication of the user's reaction to the current content may include a textual indicator from a defined taxonomy of reactions, such as “happy”, “entertained”, “excited”, “surprised”, “frustrated”, “confused”, “bored”, or the like. It should be understood that other appropriate quantifiable indications of user reaction may also or alternatively be used in certain implementations. It should also be understood that multiple indications of user reaction may be used in various appropriate combinations.

Content computer 18 may compare the indication of the user's reaction to an indication of intended reaction associated with the current content to determine an efficacy value of the current content. The indication of intended reaction may be stored in association with the content, and may be defined, for example, by the author or publisher of the content. For example, an author may tag his content as comedic such that the intended reaction from users is laughter. As another example, the author may tag his content with a low likability score if he intends for the content to be viewed with anger or frustration that is consistent with the message he is intending to convey (e.g., an anti-drug campaign that shows the negative effects that illegal drug use can have on communities).

The determined efficacy value may represent a level of correlation between the user's reaction and the intended reaction. For example, if the user is entertained by content that is intended to be funny, or if the user is frustrated with content that is intended to be consternating, then the efficacy value may be relatively high, e.g., to indicate a match (or a positive correlation) between the user's reaction and the intended reaction. On the other hand, if the user is entertained with content that is intended to be unpleasant, or if the user is frustrated by content that is supposed to be funny, then the efficacy value may be relatively low, e.g., to indicate a disconnect between the actual and intended reactions.

In some cases, the content may be logically divided into two or more segments, each of which may be associated with different or similar intended reactions. For example, a thirty second advertisement may start with a five second attention-grabbing scene that is intended to shock the audience, and may then switch to a scene that is intended to entertain the audience for the remaining twenty-five seconds. In such cases, comparing the indication of user reaction to the indication of intended reaction may include comparing the actual reactions exhibited during playback of the different segments to the respective intended reactions for those segments, and determining a composite efficacy value for the content. In other implementations, an efficacy value may be determined for both of the respective segments to ensure that the appropriate reaction is being elicited from the audience—first a reaction of shock at the attention-grabbing scene, and then a reaction of amusement during the entertaining scene.

Based on the efficacy value, content computer 18 may select a targeted content item for playback on the display. For example, if the current content is intended to be entertaining, and the user is observed to be laughing (e.g., the efficacy value shows a positive correlation between actual and intended response), then another entertaining content item may be selected for display to the user. However, if the user is instead observed to be frowning at content that is intended to be entertaining, then the content computer may select a different type of content for display to the user.

In some implementations, if the efficacy value of the current content item is greater than a threshold efficacy value, content computer 18 may select a targeted content item that shares a common characteristic with the current content item (e.g., intended reaction=“comedic”; likability score=“9”; etc.), and may cause playback of the selected targeted content item to be queued for playback after the current content item has completed. If the efficacy value of the current content item is less than a threshold efficacy value, content computer 18 may cause playback of the current content item to be stopped before completion, and may cause playback of the selected targeted content item to begin in its place.

Content computer 18 may provide the selected content to the display device 20 directly or via display computer 24. The display device 20 (and in some cases the audio speaker 22) may then present the selected content to the audience members (i.e., users of the display device 20). The content may be digital, multimedia content which can be in the form of commercial advertisements, entertainment, political advertisements, survey questions, or any other appropriate type of content.

Content computer 18 may also store the indication of user reaction to the content for later use. For example, system 10 may include a data store for storing the indicia of user reactions to the content, e.g., based on multiple users' reactions and/or reactions gathered over time, in association with the respective content. In some implementations, such stored indicia may be used to automatically classify the content. For example, if the user reaction from a majority of users to a particular content item was laughter, then the system 10 may classify the content item as comedic. As another example, system 10 may assign an average likability score based on multiple users' reactions to the content. Such stored indications may be used by content owners to analyze what types of reactions were elicited from their respective content, e.g., at particular times and/or in particular locations, and may inform future content decisions by the content owners.

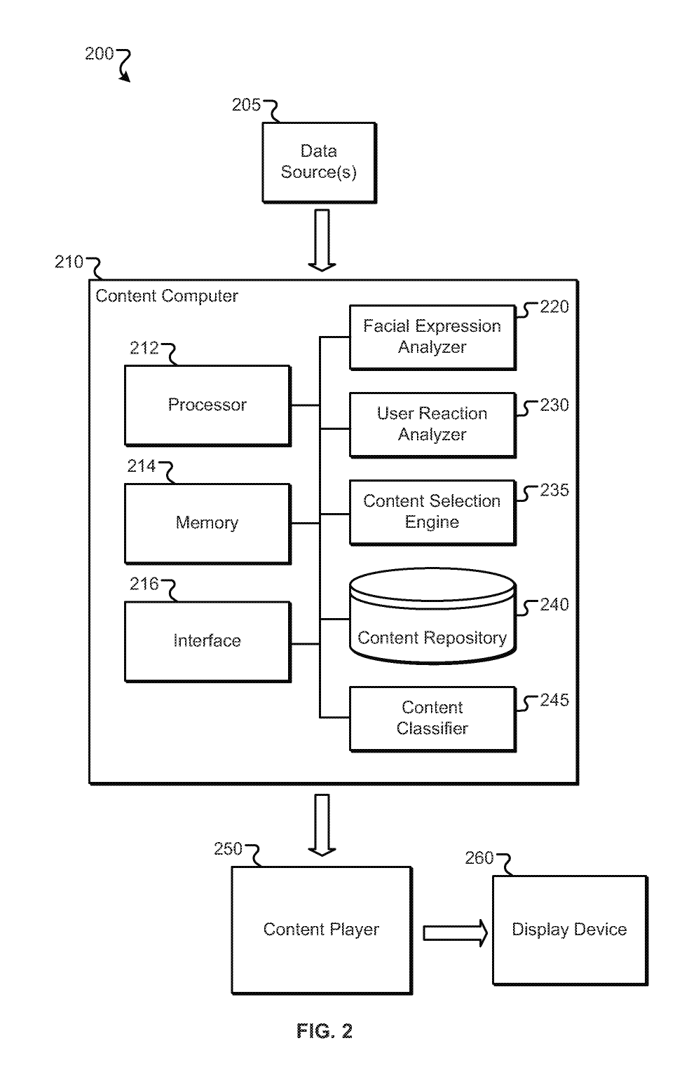

FIG. 2 is a block diagram of an example system 200 for providing targeted content based on user reactions. System 200 includes one or more data source(s) 205 communicatively coupled to content computer 210. The one or more data source(s) 205 may provide one or more inputs to content computer 210. The content computer 210 may be configured to select content for playback based on the one or more inputs, and to provide the selected content to content player 250 for playback on display 260.

Data source(s) 205 may include, for example, an image capture device (e.g., a camera) or an application that provides an image to the content computer 210. As used here, an image is understood to include a snapshot, a frame or series of frames (e.g., one or more video frames), a video stream, or other appropriate type of image or set of images. In some implementations, multiple image capture devices or applications may be used to provide images to content computer 210 for analysis. For example, multiple cameras may be used to provide images that capture different angles of a specific location (e.g., multiple views of an audience in front of a display), or different locations that are of interest to the system 200 (e.g., views of customers entering a store where the display is located).

Data source(s) 205 may also include an extrinsic attribute detector to provide extrinsic attributes to content computer 210. Such extrinsic attributes may include features that are extrinsic to the audience members themselves, such as the context or immediate physical surroundings of a display system. Extrinsic attributes may include time of day, date, holiday periods, a location of the presentation device, or the like. For example, a location attribute (children's section, women's section, men's section, main entryway, etc.) may specify the placement or location (e.g., geo-location) of the display 260, e.g., within a store or other space. Another example of an extrinsic attribute is an environmental parameter (e.g., temperature or weather conditions, etc.). In some implementations, the extrinsic attribute detector may include an environmental sensor and/or a service (e.g., a web service or cloud-based service) that provides environmental information including, e.g., local weather conditions or other environmental parameters, to content computer 210.

As shown, content computer 210 may include a processor 212, a memory 214, an interface 216, a facial expression analyzer 220, a user reaction analyzer 230, a content selection engine 235, and a content repository 240. It should be understood that these components are shown for illustrative purposes only, and that in some cases, the functionality being described with respect to a particular component may be performed by one or more different or additional components. Similarly, it should be understood that portions or all of the functionality may be combined into fewer components than are shown.

Processor 212 may be configured to process instructions for execution by the content computer 210. The instructions may be stored on a non-transitory tangible computer-readable storage medium, such as in main memory 214, on a separate storage device (not shown), or on any other type of volatile or non-volatile memory that stores instructions to cause a programmable processor to perform the functionality described herein. Alternatively or additionally, content computer 210 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the functionality described herein. In some implementations, multiple processors may be used, as appropriate, along with multiple memories and/or different or similar types of memory.

Interface 216 may be used to issue and receive various signals or commands associated with content computer 210. Interface 216 may be implemented in hardware and/or software, and may be configured, for example, to receive various inputs from data source(s) 205 and to issue commands to content player 250. In some implementations, interface 216 may be configured to issue commands directly to display device 260, e.g., for playing back selected content without the use of a separate content player. Interface 216 may also provide a user interface for interaction with a user, such as a system administrator. For example, the user interface may provide an input that allows a system administrator to control weightings or other rules associated with fine-tuning the parameters of a rule set that defines how various user reactions are defined.

Facial expression analyzer 220 may execute on processor 212, and may be configured to extract facial features of a user from an image, such as an image received from data source(s) 205, and to identify a facial expression of the user based on the extracted facial features. Facial expression analyzer 220 may implement facial detection and recognition techniques to detect distinct faces included in an image. The facial detection and recognition techniques may determine boundaries of a detected face, such as by generating a bounding rectangle (or other appropriate boundary), and may analyze various facial features, such as the size and shape of an individual's mouth, eyes, nose, cheekbones, and/or jaw, to generate a digital signature that uniquely identifies the individual to the system without storing any personally-identifiable information about the individual.

Facial expression analyzer 220 may extract one or more facial features and the relative positioning of such facial features for a particular individual, and may determine that the specific combination of features and positioning correspond to a particular facial expression for that individual. In some cases, such a determination may be made for all of the individuals in the image, or for one or more selected individuals. In some implementations, facial expression analyzer 220 may initially focus on one of the individuals in the image and identify a facial expression of the individual, and may process other individuals in a similar manner until some or all of the facial expressions have been identified.

User reaction analyzer 230 may execute on processor 212, and may be configured to determine a user reaction to the current content being displayed on display device 260 based at least in part on the facial expression of the user viewing the current content. For example, user reaction analyzer 230 may determine that the user is happy or entertained by the current content, e.g., if the user is smiling or laughing; or may determine that the user is unhappy or frustrated with the current content, e.g., if the user is frowning or shaking her head.

In some implementations, user reaction analyzer may be implemented with a rule set that maps one or more facial expressions to a user reaction. The rule set may be configurable, and may include weightings that allow an administrator to fine-tune how various user reactions are defined, e.g., according to cultural or social norms in the area where the digital signage installation is to be located, or according to known models that provide an effective determination of what various facial expressions may mean in a given context.

In some implementations, the user's reaction to the current content may be quantified using a numerical score on a likability scale, e.g., where a score of ten (based on an expression of amazement, dilated pupils, and a smile) indicates that the user very much likes the content, and a score of one (based on an expression of disgust) indicates that the user very much dislikes the content. In some implementations, the user's reaction to the current content may be quantified using a textual indicator from a defined taxonomy of reactions, such as “happy”, “entertained”, “excited”, “surprised”, “frustrated”, “confused”, “bored”, or the like. It should be understood that other appropriate quantifiable indications of user reaction may also or alternatively be used in certain implementations. It should also be understood that multiple indications of user reaction may be used in various appropriate combinations.

Content selection engine 235 may execute on processor 212, and may be configured to determine an indication of efficacy of the current content being displayed on display device 260, and to select other content (e.g., from a set of available content items) for playback on display device 260 based at least in part on the indication of efficacy. To determine the indication of efficacy of the current content, content selection engine 235 may compare the user reaction (as determined by the user reaction analyzer) to an intended reaction associated with the current content. The intended reaction may be defined, for example, by the author or publisher of the content, and may be stored in association with the content (e.g., as a tag or other metadata associated with the content).

In some implementations, the indication of efficacy may be an efficacy value that represents a level of correlation between the user's reaction and the intended reaction. For example, if the user is entertained by content that is intended to be funny, or if the user is frustrated with content that is intended to be consternating, then the efficacy value may be relatively high, e.g., to indicate a match (or a positive correlation) between the user's reaction and the intended reaction. In some cases, when the efficacy value is determined to be greater than a defined threshold value, the content selection engine 235 may select other content (e.g., from a set of available content items) that shares a common characteristic with the current content, and/or may cause the selected other content to be played back after playback of the current content has completed. On the other hand, if the user is entertained with content that is intended to be unpleasant, or if the user is frustrated by content that is supposed to be funny, then the efficacy value may be relatively low, e.g., to indicate a disconnect between the actual and intended reactions. In some cases, when the efficacy value is determined to be less than a defined threshold value, the content selection engine 235 may cause playback of the current content to be stopped before it has completed playing, and may replace the current content with the other selected content to be played back.

The indication of efficacy may also be any other appropriate mechanism that represents whether a user's reaction to content aligns with an intended reaction associated with the content. Other appropriate mechanisms may include, for example, a simple match versus non-match indication, or an indication that quantifies the “closeness” of the match, or a partial match, between the user's reaction and the intended reaction (e.g., a 70% match, or a “near match” indication).

In some cases, the content may be divided into multiple segments, with each segment being associated with an intended reaction. In such cases, determining the indication of efficacy of the content may include comparing the actual reactions exhibited during playback of the multiple segments to the respective intended reactions for those segments.

Content repository 240 may be communicatively coupled to the content selection engine 235, and may be configured to store content (e.g., content that is ultimately rendered to an end user) using any of various known digital file formats and compression methodologies. Content repository 240 may also be configured to store targeting criteria, intended reactions to content, and/or indicia of intended reactions to content in association with each of the content items. As used here, the targeting criteria (e.g., a set of keywords, a set of topics, query statement, etc.) may include a set of one or more rules (e.g., conditions or constraints) that set out the circumstances under which the specific content item will be selected or excluded from selection. For example, a particular content item may be associated with a particular intended reaction, and if the content selection engine 235 determines that a current content item is eliciting a particular intended reaction from an individual viewing the current content, then content selection engine 235 may select another content item that is similar to the current content item for playback after the current content item has completed playing.

Content repository 240 may also be configured to store user reactions and/or indicia of user reactions in association with the various stored content items. Such stored reactions may be used by content owners to analyze what types of reactions were elicited from their respective content items, e.g., at particular times and/or in particular locations, and may be used to inform future content decisions by the content owners.

In some implementations, a content classifier 245 may use such stored user reactions to automatically classify the content stored in the content repository 240. For example, if the user reaction from a majority of users to a particular content item was laughter, then the content classifier 245 may classify the content item as comedic. As another example, content classifier 245 may assign an average likability score based on multiple users' reactions to the content.

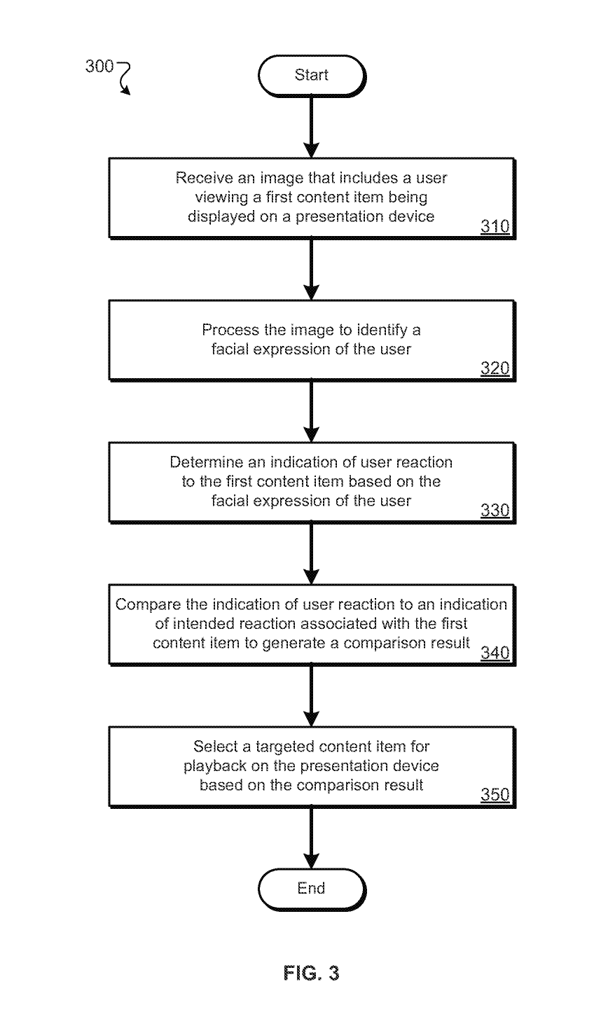

FIG. 3 is a flow diagram of an example process 300 for selecting targeted content based on user reactions. The process 300 may be performed, for example, by a content computer such as the content computer 18 illustrated in FIG. 1. For clarity of presentation, the description that follows uses the content computer 18 illustrated in FIG. 1 as the basis of an example for describing the process. However, it should be understood that another system, or combination of systems, may be used to perform the process or various portions of the process.

Process 300 begins at block 310 when a computer system, such as content computer 18, receives an image that includes a user viewing a first content item being displayed on a presentation device. The image may be received from an image capture device, such as a still camera, a video camera, or other appropriate device positioned to capture the user of the presentation device.

At block 320, content computer 18 may process the received image to identify a facial expression of the user. For example, in some implementations the content computer 18 may initially focus on one of the viewers of the presentation device, and may extract facial features of the viewer to identify a facial expression associated with the viewer. Content computer 18 may also process other viewers in a similar manner until some or all of the facial expressions of the individuals in the image have been identified.

At block 330, content computer 18 may determine an indication of user reaction to the first content item based on the facial expression(s) of the user(s). In some implementations, content computer 18 may map one or more identified facial expressions to one or more user reactions to the content. For example, a smiling facial expression may be mapped to a user reaction of entertainment and/or happiness.

At block 340, content computer 18 may compare the indication of user reaction to an indication of intended reaction associated with the first content item to generate a comparison result. For example, a first content item may be tagged as having an intended reaction of happiness or entertainment. Continuing with the example above, if a user reaction indicates that the user is entertained and/or happy when viewing the content item, the comparison result may indicate a match between the user reaction and the intended reaction. If, on the other hand, the user reaction indicates that the user is merely content (but not happy or entertained), or indicates that the user is unhappy when viewing the content item, the comparison result may indicate a partial match or a non-match, respectively.

At block 350, content computer 18 may select a targeted content item for playback on the presentation device based on the comparison result. For example, if the comparison result indicates a match between the user reaction and the intended reaction, the content computer 18 may select a targeted content item for playback that is similar to the first content item. If the comparison result indicates a partial match or a non-match, the content computer 18 may select a targeted content item for playback that is different from the first content item. In some cases, content computer 18 may continue process 300 until the comparison result indicates a match between the user reaction and the intended reaction for the content item being played back on the presentation device.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

1. A method for selecting a targeted content item for playback, the method comprising:
receiving, at a computer system and from an image capture device, an image that includes a user who is viewing a first content item being displayed on a presentation device;
processing the image, using the computer system, to identify a facial expression of the user;
determining, using the computer system, an indication of user reaction to the first content item based on the identified facial expression of the user;
comparing, using the computer system, the indication of user reaction to an indication of intended reaction associated with the first content item to determine an efficacy value of the first content item;
selecting, using the computer system, a targeted content item for playback on the presentation device based on the efficacy value; and
in response to determining that the efficacy value is less than a threshold value, causing playback of the first content item to be stopped before completion, and causing playback of the targeted content item to begin after playback of the first content item has been stopped.

2. (canceled)

3. The method of claim 1, further comprising, in response to determining that the efficacy value is greater than a threshold value, causing playback of the targeted content item to begin after playback of the first content item has completed.

4. The method of claim 1, wherein selecting the targeted content item for playback comprises selecting a content item that shares a common characteristic with the first content item in response to determining that the efficacy value is greater than a threshold value.

5. The method of claim 1, further comprising storing the indication of user reaction to the first content item in association with the first content item.

6. The method of claim 5, further comprising classifying the first content item based on a plurality of stored indicia of user reactions associated with the first content item.

7. The method of claim 1, wherein the first content item includes a first segment that is associated with a first indication of intended reaction and a second segment that is associated with a second indication of intended reaction that is different from the first indication, and wherein comparing the indication of user reaction to the indication of intended reaction comprises comparing a first indication of user reaction exhibited during playback of the first segment to the first indication of intended reaction, and comparing a second indication of user reaction exhibited during playback of the second segment to the second indication of intended reaction.

8. A system for selecting content, the system comprising:
a presentation device that displays first content to a user;
an image capture device that captures an image of the user;
a facial expression analyzer, executing on a processor, that extracts facial features of the user from the image, and identifies a facial expression of the user based on the extracted facial features;
a user reaction analyzer, executing on a processor, that determines a user reaction to the first content based on the facial expression of the user; and
a content selection engine, executing on a processor, that determines an indication of efficacy of the first content based on a comparison of the user reaction to an intended reaction associated with the first content, and selects second content for playback on the presentation device based on the indication of efficacy;
wherein, in response to determining that the indication of efficacy of the first content is less than a threshold value, the content selection engine causes playback of the first content to be stopped before completion, and causes playback of the second content to begin after playback of the first content has been stopped.

9. (canceled)

10. The system of claim 8, wherein, in response to determining that the indication of efficacy of the content is greater than a threshold value, the content selection engine causes playback of the second content to begin after playback of the first content has completed.

11. The system of claim 8, wherein the content selection engine selects the second content based on a shared common characteristic with the first content in response to determining that the indication of efficacy of the content is greater than a threshold value.

12. The system of claim 8, further comprising a content data store that stores content items and user reactions to the content items, and wherein the content selection engine stores the user reaction to the first content in association with the first content in the content data store.

13. The system of claim 12, further comprising a content classifier that classifies the first content based on a plurality of stored user reactions associated with the first content.

14. The system of claim 8, wherein the first content includes a first segment that is associated with a first intended reaction and a second segment that is associated with a second intended reaction that is different from the first intended reaction, and wherein determining the indication of efficacy comprises comparing a first user reaction exhibited during playback of the first segment to the first intended reaction, and comparing a second user reaction exhibited during playback of the second segment to the second intended reaction.

15. A non-transitory computer-readable storage medium storing instructions that, when executed by a processor, cause the processor to:
receive, from an image capture device, an image that includes a user who is viewing a first content item being displayed on a presentation device;
extract facial features of the user from the image to identify a facial expression of user;
determine an indication of user reaction to the first content item based on the facial expression of the user;
compare the indication of user reaction to an indication of intended reaction associated with the first content item to generate a comparison result;
select a targeted content item for playback on the presentation device based on the comparison result; and
response to the comparison result indicating a mismatch, interrupt playback of the first it item before completion, and cause playback of the targeted content item to begin after playback of the first content item has been interrupted.
